(19) United States
(12) Patent Application Publication
(10) Pub. No.: US 2025/0108289 A1
(43) Pub. Date: Apr. 3, 2025

(54) ELECTRONIC GAMING ENVIRONMENTS WITH 3D IMMERSIVE AUDIO SYSTEMS

(71) Applicant: Aristocrat Technologies, Inc., Las Vegas, NV (US)

(72) Inventors: David Gong, Las Vegas, NV (US); Rajendrasinh Jadeja, Las Vegas, NV (US); Timothy Barbour, Franklin, TN (US); Frank Rodriguez, Las Vegas, NV (US)

(21) Appl. No.: 18/819,622

(22) Filed: Aug. 29, 2024

Related U.S. Application Data
(60) Provisional application No. 63/541,430, filed on Sep. 29, 2023.

(51) Int. Cl. A63F 13/25; G06F 3/16

(52) U.S. Cl. CPC A63F 13/25; G06F 3/165

(57) ABSTRACT

An electronic gaming system includes at least one display device, at least one array of immersive sound speakers positioned adjacent the at least one display device, and a memory device in electronic communication with the at least one display device, where the memory device stores instructions. Additionally, the electronic gaming system includes a game controller comprising a processor configured to execute the instructions stored in the memory device, which, when executed, cause the game controller to cause to be displayed gaming events on the at least one display device. Additionally when executed, the instructions stored in the memory device cause the game controller to output audio data, via the at least one array of immersive sound speakers, to create spatial sound. The spatial sound is directed to a player positioned within a localized sound bubble area, opposite the at least one display device.

### RELATED APPLICATION(S)

The present application claims priority to U.S. Provisional Patent Application No. 63/541,430, filed Sep. 29, 2023, and entitled “ELECTRONIC GAMING ENVIRONMENT WITH 3D IMMERSIVE AUDIO SYSTEM” which is hereby incorporated by reference in its entirety.

### TECHNICAL FIELD

The field of disclosure relates generally to an electronic gaming environment, and more specifically, to electronic gaming machines and community gaming systems having three (3) dimensional (3D) immersive audio systems.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic device includes at least one display device; at least one array of immersive sound speakers positioned adjacent the at least one display device; a memory device in electronic communication with the at least one display device, the memory device storing instructions; and a game controller comprising a processor configured to execute the instructions stored in the memory device, which, when executed, cause the game controller to: cause to be displayed gaming events on the at least one display device; and output audio data, via the at least one array of immersive sound speakers, to create spatial sound, the spatial sound directed to a player positioned within a localized sound bubble area, opposite the at least one display device.

In another aspect, a community gaming system including at least one central community display device; a plurality of electronic gaming machines (EGMs) in electronic communication with each other and the at least one central community display device, each EGM of the plurality of EGMs including at least one array of immersive speakers positioned adjacent at least one display device of the EGM; a memory device in electronic communication with at least one of the at least one central community display device or the plurality of EGMs, the memory device storing instructions; and a game controller comprising a processor configured to execute the instructions stored in the memory device, which, when executed, cause the game controller to: cause to be displayed gaming events on the at least one central community display device and each EGM of the plurality of EGMs as synchronized with each other; output first audio data, via the least one array of immersive sound speakers of an EGM of the plurality of EGMs, to create a first spatial sound, the first spatial sound directed to a player positioned within a localized sound bubble area, adjacent the EGM; and output second audio data, via at least one distinct array of immersive sound speakers positioned adjacent the at least one central community display device, to create a second spatial sound, the second spatial sound directed to at least one bystander positioned within a globalized sound bubble area formed adjacent the plurality of EGMs, wherein the second spatial sound is distinct from the first spatial sound.

Additionally, in an aspect, a method of electronic gaming implemented on an electronic gaming machine includes causing to be displayed a plurality gaming events on at least one central community display device and at least one electronic gaming machine (EGM) of a plurality of EGMs of the community gaming system; outputting first audio data, via least one array of immersive sound speakers of an EGM of the plurality of EGMs, to create a first spatial sound, the first spatial sound directed to a player positioned within a localized sound bubble area, adjacent the EGM; and outputting second audio data, via at least one distinct array of immersive sound speakers positioned adjacent the at least one central community display device, to create a second spatial sound, the second spatial sound directed to at least one bystander positioned within a globalized sound bubble area formed adjacent the plurality of EGMs, wherein the second spatial sound is distinct from the first spatial sound.

In another aspect, an electronic gaming device including at least one display device, at least one array of immersive sound speakers, a memory device storing instructions, and a game controller including a processor is disclosed. The processor is configured to execute the instructions stored in the memory device, which, when executed, cause the game controller to cause display of gaming events on the at least one display device, and output audio data to the at least one array of immersive sound speakers causing spatial sound to be outputted via the at least one array of immersive sound speakers. The spatial sound is directed to a player within an engagement area at the electronic gaming device.

In another aspect, a community gaming system is disclosed. The community gaming system includes at least one central community display device, a plurality of electronic gaming machines (EGMs) linked with each other and the at least one central community display device, a memory device storing instructions, and a game controller including a processor. The processor is configured to execute the instructions stored in the memory device, which, when executed, cause the game controller to: (i) cause display of gaming events on the at least one central community display device and on each EGM of the plurality of EGMs as synchronized with each other; (ii) output first audio data to at least one array of immersive sound speakers of an EGM of the plurality of EGMs causing spatial sound corresponding to the first audio data to be outputted directed to a player within an engagement area at the EGM via the at least one array of immersive sound speakers of the EGM; and/or (iii) output second audio data to at least one array of immersive sound speakers at the at least one central community display device causing spatial sound corresponding to the second audio data to be outputted directed to bystanders around the at least one central community display device via the at least one array of immersive sound speakers of the at least one central community display device.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A is an exemplary EGM having a 3D immersive audio sound system in accordance with embodiments of the present disclosure.

FIG. 4B is another exemplary EGM having a 3D immersive audio sound system in accordance with embodiments of the present disclosure.

FIG. 4C is a block diagram illustrating an exemplary embodiment of an EGM having a 3D immersive audio sound system in accordance with embodiments of the present disclosure.

FIGS. 4D and 4E illustrate another exemplary embodiment of an EGM having a 3D immersive audio sound system in accordance with embodiments of the present disclosure.

FIG. 5 illustrates an exemplary view of a game chair with a plurality of linear arrays of immersive sound speakers in accordance with embodiments of the present disclosure.

FIGS. 6A-6C illustrate exemplary views of a community gaming system including a central community display and a bank of EGMs in accordance with embodiments of the present disclosure.

### DETAILED DESCRIPTION

Conventional EGMs are generally more suitable for individual game play and are not used for community play. Such conventional EGMs are equipped with standard stereo speakers for playing game sounds, game music, instructions, and so on. Accordingly, many electronic games played on electronic gaming machines are not offered as community games. With an increase in popularity of sport leagues and sport franchises, along with sporting events played in large stadiums and arenas, a game player's desire to be a participant in such community events, e.g., community games, has also increased. In such community games, multiple EGMs or other gaming devices are communicatively coupled to create a bank of EGMs. The systems and methods described herein include a gaming device and/or a bank of gaming devices, which may include EGMs and/or a bank of EGMs, that are equipped with a unique 3D immersive sound system so that players engaged in a community game on the bank of EGMs (or even playing a single game on a single gaming device) may experience being part of the community game.

In some embodiments, each EGM of the bank of EGMs is equipped with immersive audio speakers that are configured in a linear array. Additionally, or alternatively, a plurality of linear arrays of immersive audio speakers may be installed at each EGM of the bank of EGMs. Accordingly, in contrast to a conventional EGM sound system that cannot create a 3D immersive sound environment and/or cannot replicate the sound, for example, of an object moving through a crowd or along a field of play, the EGMs having the unique 3D immersive sound system are equipped with immersive audio speakers, as described herein. The audio speakers and systems described herein are configured to create an immersive environment of 3D sound. Further, each EGM of the bank of EGMs may be communicatively coupled with a central community display on which the community game may be played and displayed. The community game being played on the central community display may also be displayed on a display device of each EGM of the bank of EGMs. In other words, certain game data may be displayed on the central community display while other data may be displayed on the individual displays of each EGM.

Using one or more linear arrays of immersive sound speakers, audio can be uniquely directed to a player playing at the EGM of the bank of EGMs. The central community display that is equipped with one or more distinct linear arrays of immersive audio speakers may further create an immersive audio experience for bystanders near the central community display. As explained below, the array of audio speakers at the EGM including the directional configuration of those speakers, in combination with the array of speakers at the central community display and their directional configuration, can create an immersive environment of sound that envelops a player of the EGM, as well as bystanders within a predetermined area surrounding the player or central community display.

In some embodiments, two or more neighboring EGMs may be coupled to form a bank of EGMs, and the central community display may be behind the bank of EGMs in the direction of view of the players. In some examples, the central community display and the bank of EGMs may be physically separated such that spectators may gather around the central community display, either behind or in front of the bank of EGMs, and view the ongoing game on the central community display. Each player of an EGM of the bank of EGMs may view the ongoing game on the display device of the EGM, while also being able to view the central community display.

As described herein, an EGM of the bank of EGMs may provide immersive 3D audio to a player using one or more linear arrays of speakers. The one or more linear arrays of speakers may be located on the EGM and each array of speakers may include multiple speakers that are positioned along a line and in a horizontal plane. In some examples, a linear array of speakers may be positioned at a top edge of the display of the EGM and/or at a bottom edge of the display of the EGM. If the EGM includes multiple displays, a linear array of speakers may be positioned between the two displays of the EGM in a horizontal plane. Additionally, or alternatively, one or more speakers may be located along a vertical border of the EGM. Using the one or more linear arrays of immersive sound speakers, game sounds, board sounds, game music, and the like, may be presented and heard by the player in a synchronized fashion. In non-limiting examples, these synchronized sounds may be controlled by an audio controller at the EGM, by a central audio controller at the central community display, and/or at a central server with gaming events being displayed on the display of the EGM, and, also on the central community display.

In some embodiments, conventional speakers (e.g., mono, or stereo speakers) on the EGM may be removed and replaced with one or more linear arrays of 3D immersive speakers. A 3D immersive audio signal may be sent to the one or more linear arrays to play game sounds, board sounds, game music, and/or game instructions, synchronized with the game events being displayed on the EGM. The 3D immersive audio signal may be created, for example, using computer-implemented instructions stored at the EGM, and/or at a gaming application server that is communicatively coupled with the EGM. The 3D immersive sound generated by the one or more linear arrays of immersive sound speakers is highly directional and can generate audio originating at a specific spot in a 3D space and/or generate audio directed to a specific spot in a 3D space. In other words, for a single EGM equipped with one or more linear arrays of immersive sound speakers, a bubble or 3D space surrounding a player at the EGM may be created such that the player is immersed with 3D immersive audio. Therefore, the position of the player and, in some cases, the positions of bystanders surrounding the player, may be predetermined so that the linear array of sound speakers can be configured to surround the player and/or bystanders with sound.

In addition to a single EGM being equipped with one or more linear arrays of immersive sound speakers, multiple EGMs may be linked with each other to create a bank of EGMs for a community gaming environment. Linked EGMs of the bank of EGMs may be neighboring EGMs. The linked EGMs may be arranged, for example, in a single line and/or along an arc of a circle. The circle may represent an arena or a stadium. A community game may be displayed on a central community display, which may further include a linear array of immersive sound speakers generating directional and/or spatial audio. The linear array of immersive sounds speakers may generate immersive sound directed to players sitting in front of each EGM, to bystanders in the vicinity of each EGM, and/or in an area between the bank of EGMs and the central community display.

In some embodiments, the central community display may have an active display area that is dynamically updated based on the community game being played. For example, for a community game, such as a football game, the central community display may have an active display area that is rectangle in shape and looks like a football field. For a community game like a roulette game, the central community display may have an active display area that is circular in shape, similar to a roulette wheel.

In one example embodiment, the 3D immersive sound environment may be generated in a community gaming environment that includes a roulette game as the community game being played on the central community display. As a virtual roulette ball starts spinning and bouncing around the displayed roulette wheel, immersive audio generated at an EGM of the bank of EGMs may be different based on a relative position of each EGM with respect to the roulette wheel displayed on the central community display. Accordingly, an amplitude and/or a phase shift of the immersive audio signal played at each EGM of the bank of EGMs may be different. For example, a player at an EGM near where the virtual roulette ball is bouncing on the community display may hear the sound of the ball bouncing close to him or her, while players at other EGMs may hear the sound of the virtual ball differently (e.g., the ball bouncing at a distance away from them). Similarly, players at each EGM of the bank of EGMs may experience the sound of the ball bouncing along with a direction of the ball's movement. The EGM and the central community display may generate immersive sound corresponding to the ball's movement relative to the position of the players and non-players (e.g., bystanders around each EGM and/or the central community display). By way of a non-limiting example, a game controller at an EGM and/or a game controller at the community display may select one or more sound files to be played at each speaker of an array of linear speakers at the EGM and/or the community display in accordance with a particular game event being displayed on the EGM and/or the community display.

Additionally, or alternatively, the location or presence of a player at an EGM may be determined using a sensor (e.g., an image sensor, an ultrasound sensor, a LIDAR sensor, a thermal imaging sensor, and the like) proximate to the EGM. Upon determining that the particular EGM is unoccupied by a player (e.g., no player at the EGM), the system may turn off or lessen the volume of the sound at the EGM using the linear array of immersive sound speakers. Additionally, or alternatively, upon determining that the particular EGM is unoccupied, the system may increase or update the volume of the sound at the EGM such that bystanders near the EGM may hear the sound being played during the electronic game.

Accordingly, in some non-limiting embodiments, a realistic community gaming environment, such as an electronic football game at a virtual stadium, may be generated on the EGMs and central community display. The players at the EGMs may be provided immersive sounds via the linear array of speakers to make the players feel like they may be at an actual football stadium during a football game. Each EGM of the bank of EGMs may be considered as a section of the stadium where the players are seated during the game. As sitting in different sections of the stadium may generate different sounds during an actual football game, players at the EGMs may also hear sounds differently during the virtual community football game based on their different locations at different EGMs. In one example, and during the virtual community gaming event, the “wave” may also be shown and the sound may be generated such that different EGMs of the bank of EGMs may experience the sound of the wave at different times—similar to when a crowd at an actual football stadium performs “the wave”. Accordingly, immersive sound generated at one EGM of the bank of EGMs may have a phase delay that is different from a phase delay of immersive sound generated at another EGM of the bank of EGMs for the same event.

In some embodiments, specific instructions associated with the game being played may be given to a player at a specific EGM of the bank of EGMs. The instructions may be provided using a linear array of immersive sound speakers of the specific EGM. In the example, players positioned at other EGMs and/or bystanders surrounding the central community display may not be able to hear the instructions played to the specific player at the specific EGM.

In some embodiments, an immersive audio generated by a linear array of immersive sound speakers of the central community display may be synchronized with an immersive audio generated by a linear array of immersive sound speakers of at least one EGM. In some embodiments, a size of the central community display may be apportioned into a number of array sections, and each array section may include a linear array of immersive sound speakers. The number of array sections corresponds with a number of sections of a stadium. In the non-limiting example, as the number of array sections increases, the number of immersive sound variations generated for bystanders in the vicinity of the central community display may also increase.

The immersive sound generated by a linear array of immersive sound speakers installed at an EGM is a 3D sound and not merely a conventional 2D or stereo sound. As described herein, an array of immersive sound speakers may be located near a top edge of the EGM, near a bottom edge of the EGM, in a middle section of the EGM, or any other place on the EGM. The array of immersive sound speakers of the EGM generates a localized sound bubble for a player at the EGM, and an array of immersive sound speakers at the central community display may create a global sound bubble for bystanders surrounding the central community display. Accordingly, the array of immersive sound speakers, as described herein, is configured to output a sound wave that may be directed at a specific person so that only the specific person is able to hear the 3D sound.

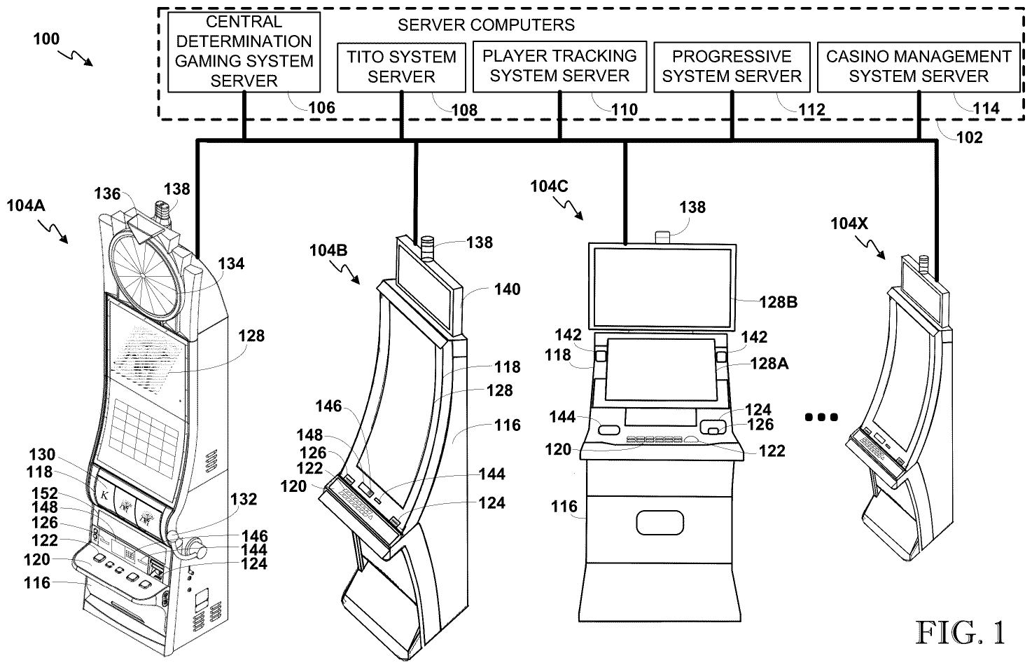

Various exemplary embodiments described herein thus produces immersive sound experience for players in a community gaming environment and are discussed below in more detail with respect to FIGS. 1-6C.

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Realm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

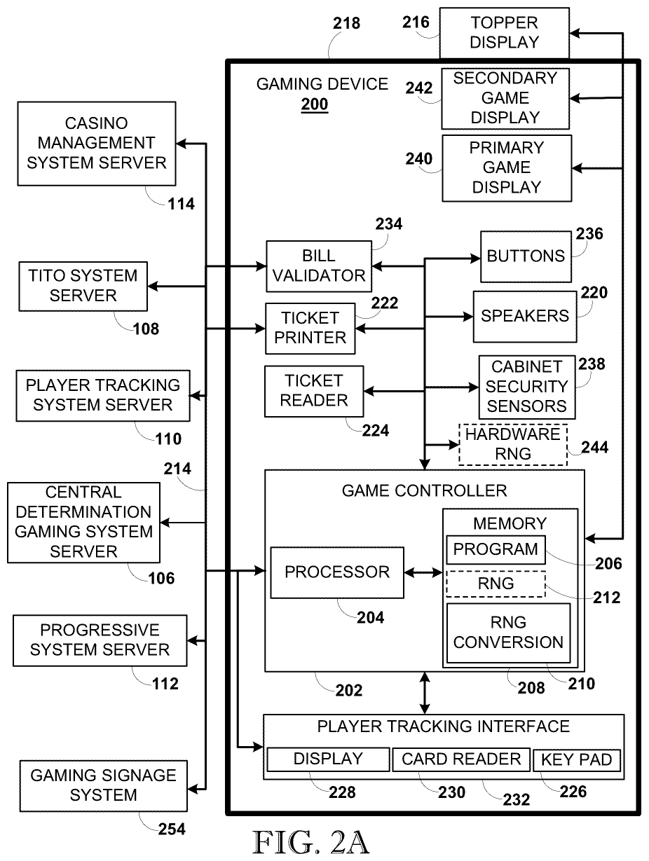

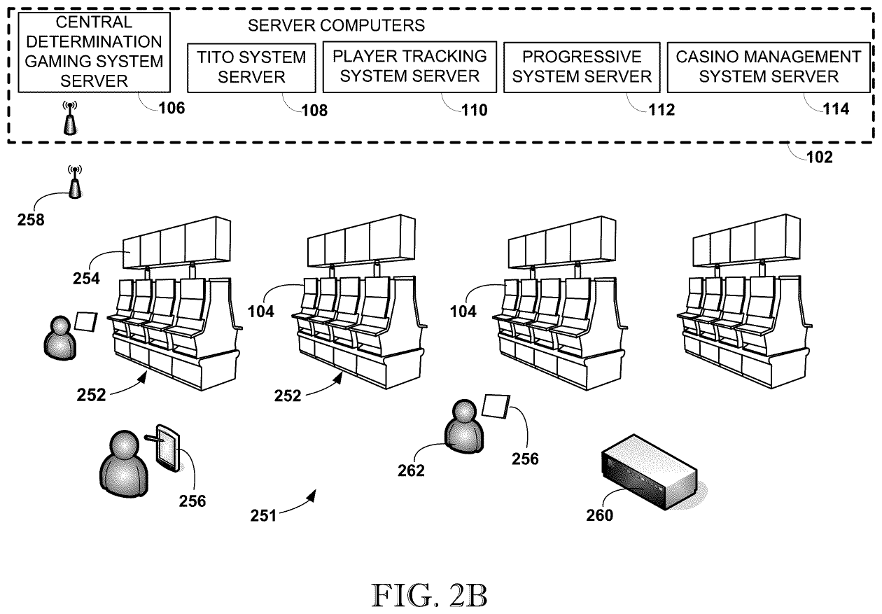

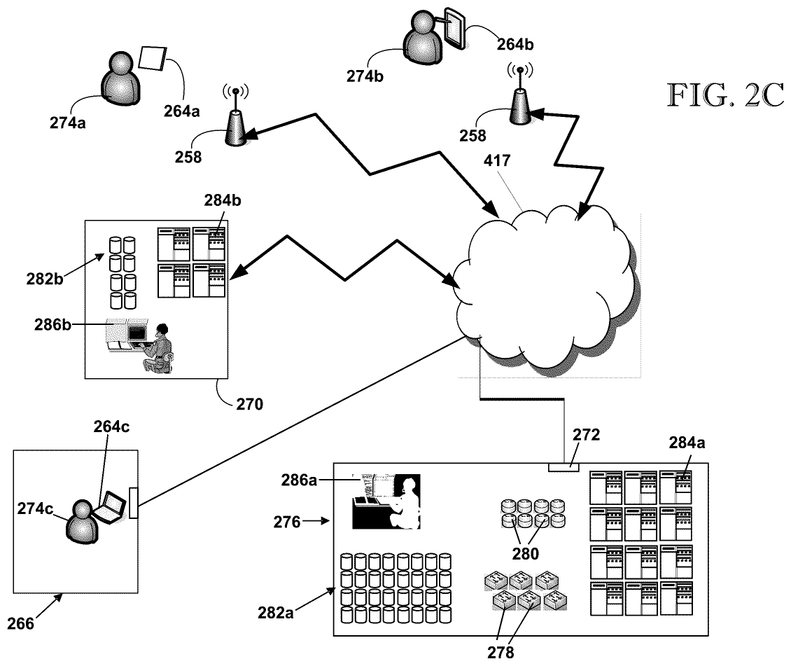

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. In general, volatility refers to the frequency or probability of an event such as a special mode, a payout, etc. For example, for a target level of RTP, a higher-volatility game may have a lower payout most of the time with an occasional bonus having a very high payout, while a lower-volatility game has a steadier payout with more frequent bonuses of smaller amounts. Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

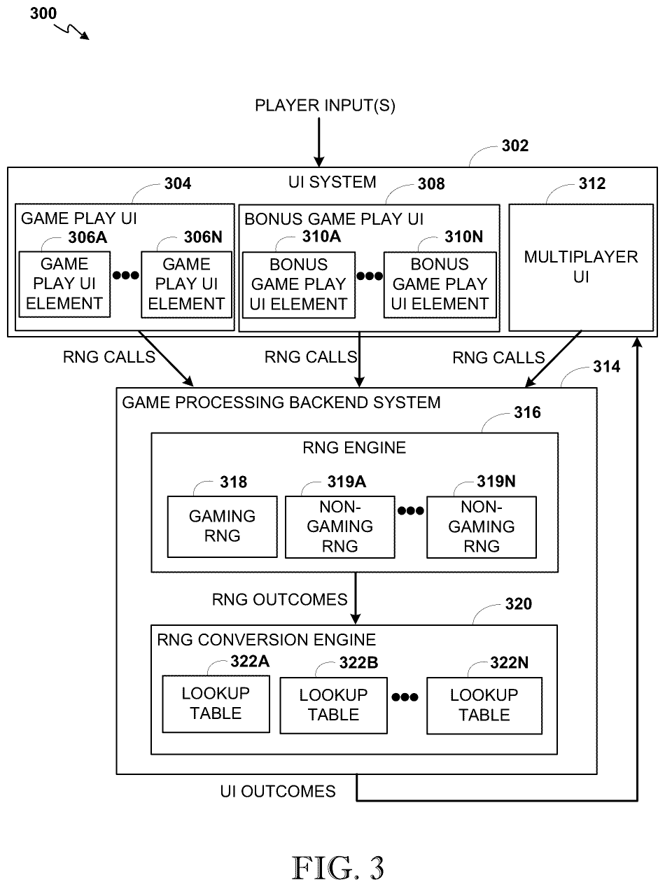

FIG. 3 illustrates, in block diagram form, an implementation of a game processing architecture 300 that implements a game processing pipeline for the play of a game in accordance with various implementations described herein. As shown in FIG. 3, the gaming processing pipeline starts with a UI system 302 receiving one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, or additionally, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

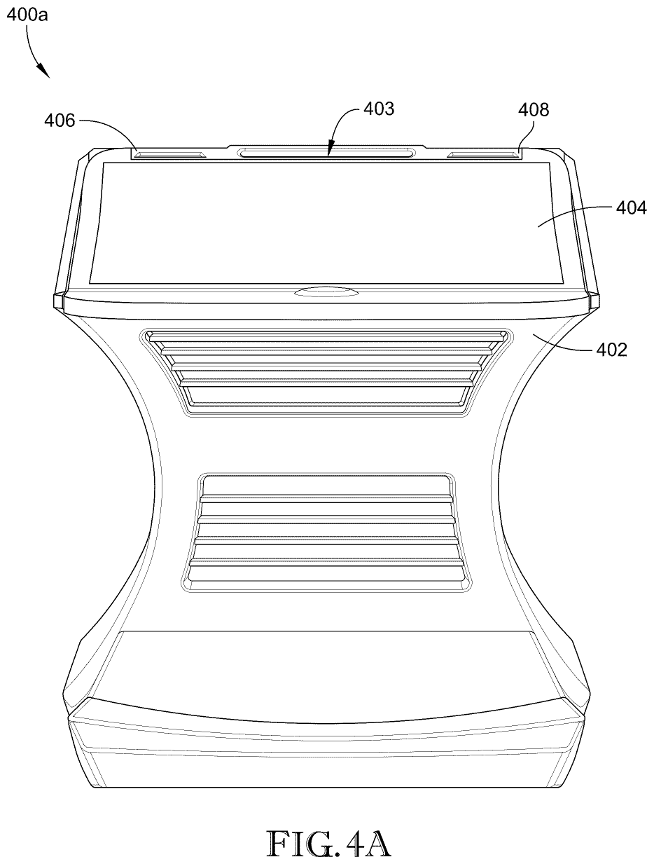

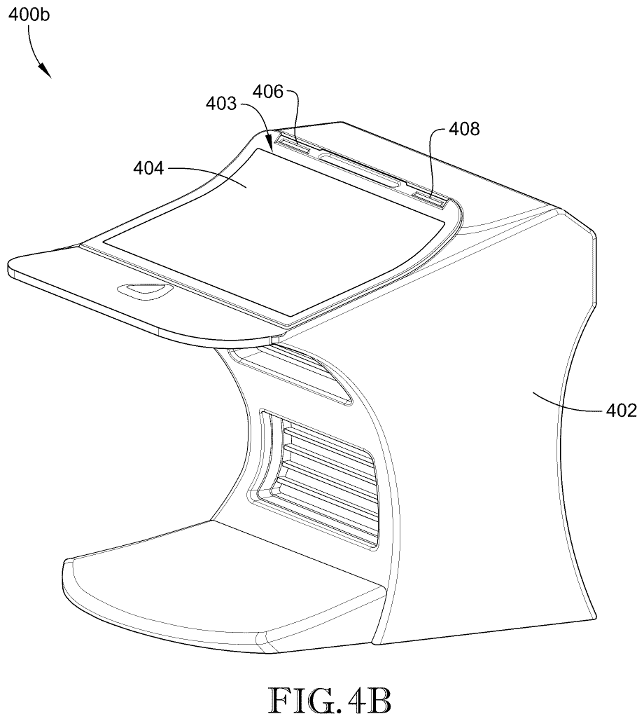

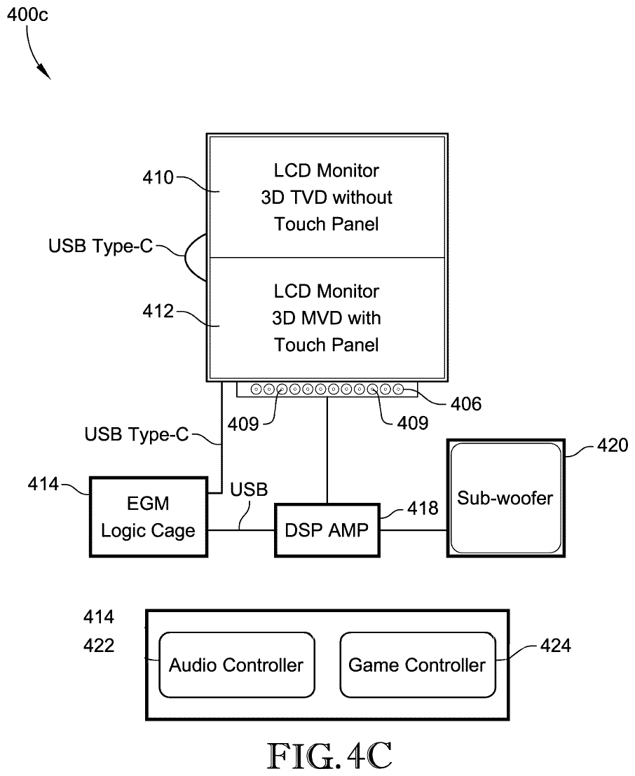

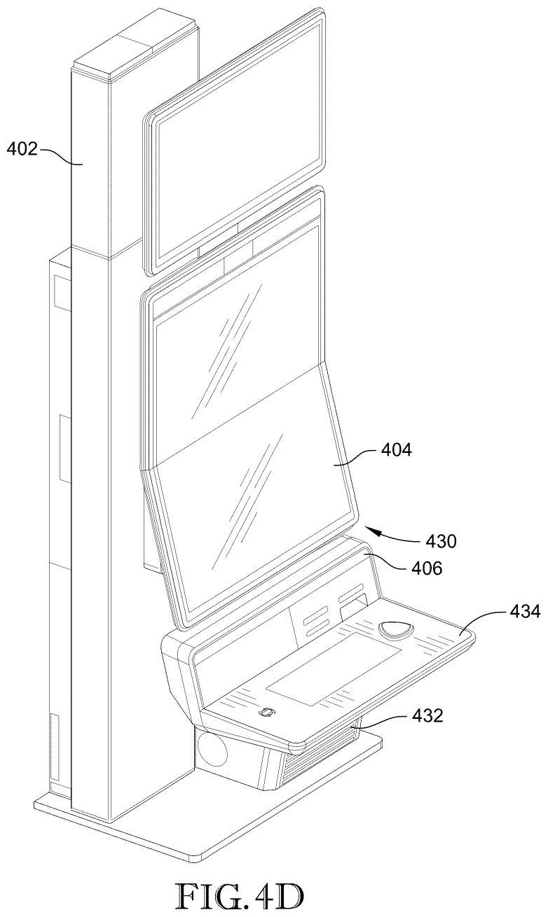

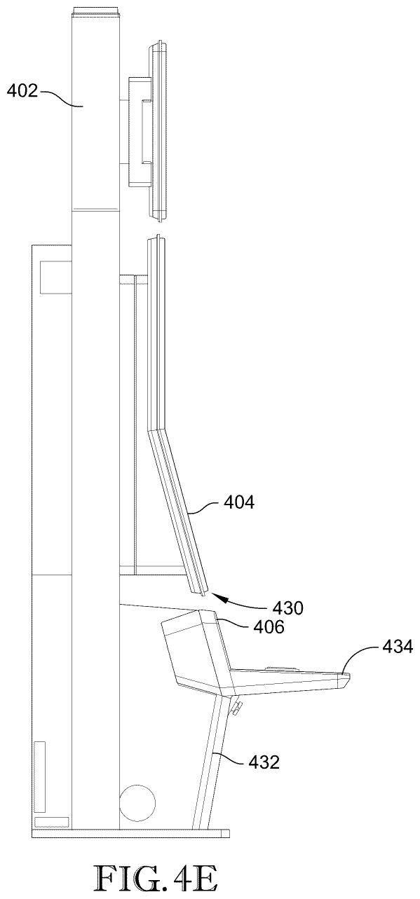

In the above, various EGMs are described that may be linked with each other to create a community gaming environment. FIG. 4A and FIG. 4B are illustrations 400a and 400b of an EGM 402 in accordance with embodiments of the present disclosure. The EGM 402 may include a display device 404. Near and/or adjacent a top edge 403 of the display device 404 for EGM 402, at least one linear array of immersive sound speakers may be provided. In the exemplary embodiment shown, EGM 402 may include a first linear array of immersive sound speakers 406 positioned adjacent to top edge 403 of display device 404, as well as a second linear array of immersive sound speakers 408 positioned adjacent to top edge 403 of display device 404. The first linear array of immersive sound speakers 406 and the second immersive sound speakers 408 may be positioned above display device 404 of EGM 402 and may also be horizontally aligned. That is, the second linear array of immersive sound speakers 408 may be positioned adjacent to and horizontally aligned with the first linear array of immersive sound speakers 406.

Alternatively, the first linear array of immersive sound speakers 406 and the second linear array of immersive sound speakers 408 may be installed on the EGM near the bottom edge of the display device 404 (see, FIG. 4D). Alternatively, the first linear array of immersive sound speakers 406 may be installed near the top edge of the display device 404, and the second linear array of immersive sound speakers 408 may be installed near the bottom edge of the display device 404.

As discussed herein (see, FIG. 4C), each linear array of immersive sound speakers 406, 408 included within EGM 402 may include a plurality of sound speakers, where each sound speaker is horizontally aligned within at least one adjacent sound speaker. Additionally, each sound speaker of the plurality of sound speakers forming the linear array of immersive sound speakers 406, 408 may be positioned a predetermined distance away and/or apart from at least one adjacent sound speaker. In exemplary embodiments where EGM 402 includes first linear array of immersive sound speakers 406 and second linear array of immersive sound speakers 408, the distance between each of the linear arrays, as well as the distance between each individual sound speaker within each distinct linear array may also be known and/or predetermined. As discussed herein, predetermining, predefining, and/or knowing the distance between the distinct linear arrays of immersive sound speakers 406, 408, as well as the plurality of sound speakers forming the linear arrays of immersive sound speakers 406, 408, facilitates the creation and/or generation of immersive 3D audio for the player(s) of EGM 402.

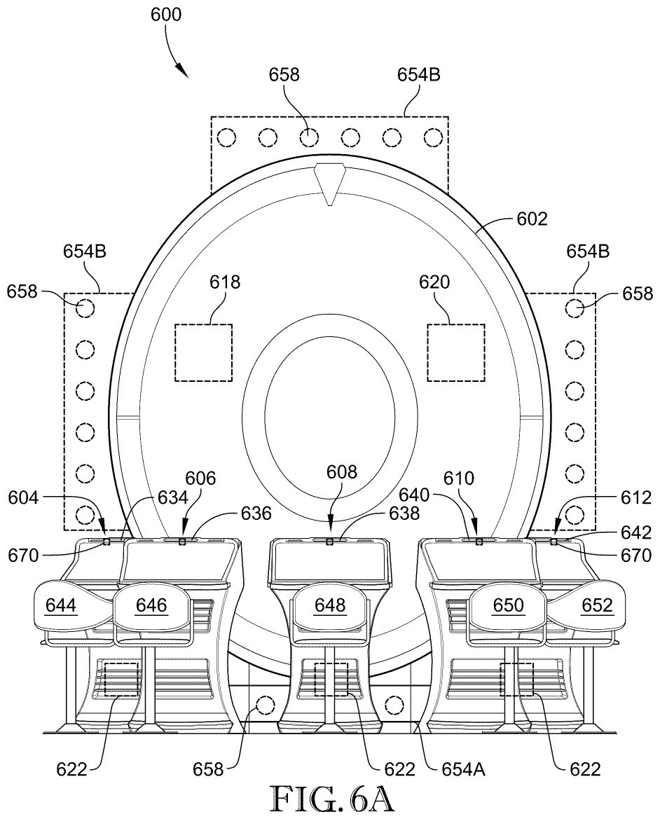

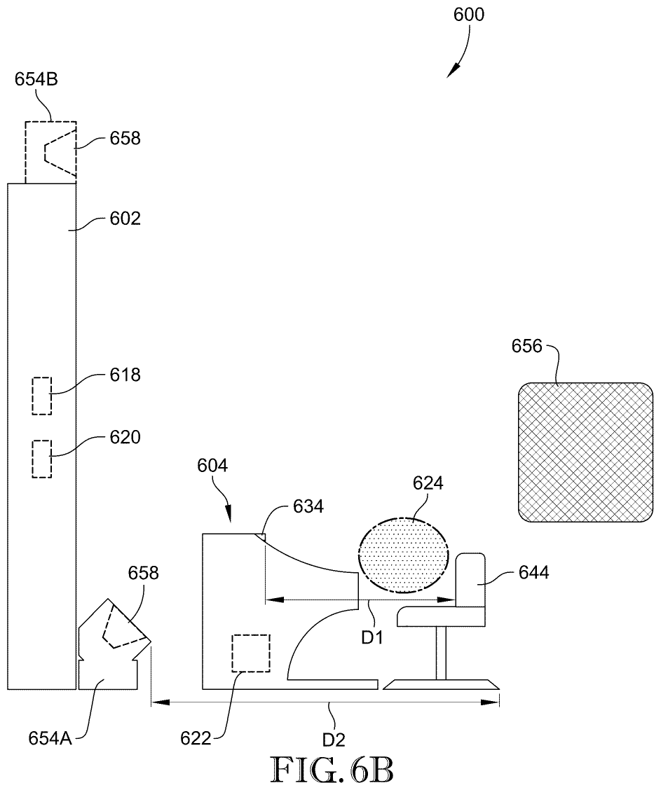

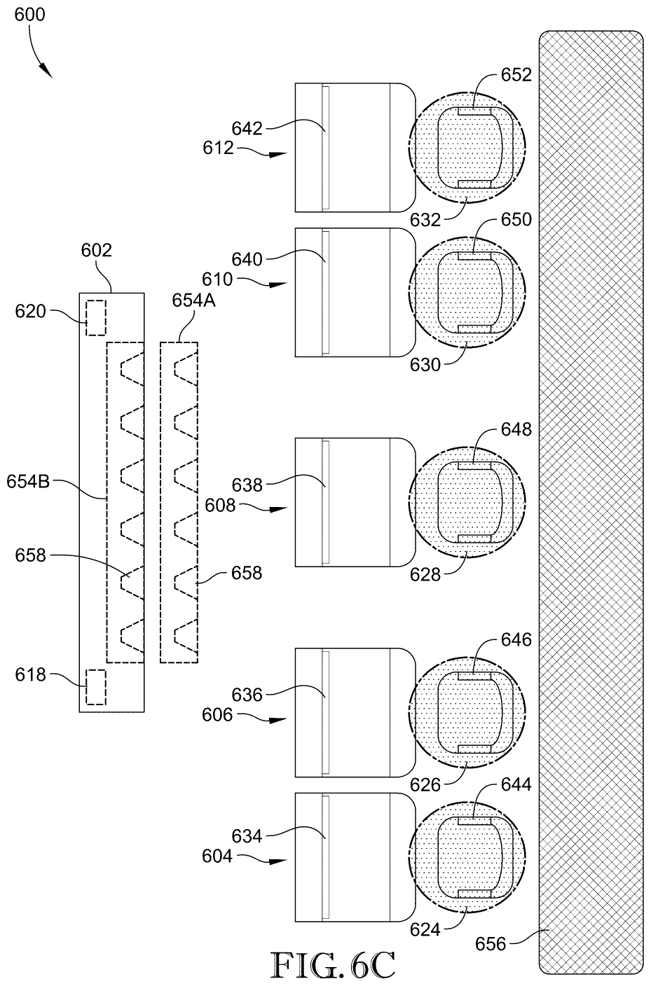

The first linear array of immersive sound speakers 406 and/or the second linear array of immersive sound speakers 408, as described herein, may generate or output audio data, that in turn creates spatial sounds for the player of the EGM 402. In non-limiting examples, the spatial sounds created by the output audio data includes, but is not limited to, game sounds, game music, player instructions, and the like. Additionally, and based on the configuration and operation of the first linear array of immersive sound speakers 406 and/or the second linear array of immersive sound speakers 408, the spatial sounds are created and/or generated as 3D immersive sounds directed to a player playing a game at the EGM 402. Accordingly, the first linear array of immersive sound speakers 406 and/or the second linear array of immersive sound speakers 408 may create a localized sound bubble area (see, FIGS. 6B and 6C) that envelops the player during game play. Accordingly, immersive sound generated by the first linear array of immersive sound speakers 406 and/or the second linear array of immersive sound speakers 408 may only be heard by a player within the localized sound bubble area at the EGM 402. The immersive sound generated by the first linear array of immersive sound speakers 406 and/or the second linear array of immersive sound speakers 408 may be synchronized with the game event being displayed on the display device 404 of the EGM 402.

The EGM 402 may also include an audio controller 422 (see, FIG. 4C), and a game controller 424 (see, FIG. 4C). The audio controller 422 may be communicatively coupled with the game controller and may play a respective audio file or audio data at each speaker of the first linear array of immersive sound speakers 406 and/or the second linear array of immersive sound speakers 408 as instructed by the game controller 424. The respective audio file or data to be played at each speaker of the first linear array of immersive sound speakers 406 and/or the second linear array of immersive sound speakers 408 may be dynamically selected by the game controller in accordance with the game event being displayed on the display device 404 of the EGM 402. In an exemplary embodiment, audio data outputted by the first linear array of immersive sound speakers 406 and/or the second linear array of immersive sound speakers 408, as instructed and/or selected by the game controller 424 can include spatial sounds corresponding to “how-to” game instructions and/or an alert that a bonus prize has been awarded after a gaming event occurs on the EGM 402. As discussed herein, and because of the localized sound bubble area created by the linear array of immersive sound speakers 406, 408, only the player sitting at the EGM 402 will hear the spatial sounds directed within the localized sound bubble area formed adjacent the EGM 402 and/or opposite the display device 404 of the EGM 402.

Additionally, or alternatively, the game controller 424 of the EGM 402 may be communicatively coupled with a game controller of a central community display (see, FIG. 6), a central server or a central controller, which may determine the respective audio file to be played at each speaker of the first linear array of immersive sound speakers 406 and/or the second linear array of immersive sound speakers 408. As discussed herein, the respective audio file or audio data played on the first linear array of immersive sound speakers 406 and/or the second linear array of immersive sound speakers 408 is in accordance with the game event being displayed at the central community display, and/or a corresponding game event being display at the EGM 402.

FIG. 4C is a block diagram 400c illustrating an exemplary embodiment of an EGM 402 having a 3D immersive audio sound system in accordance with embodiments of the present disclosure. In particular, the diagram 400c displays a single array of immersive sound speakers 406 at the EGM 402. The single array of immersive sound speakers 406 may be positioned at a bottom edge of a second display 412, which is adjacent to a first display 410, as shown in FIG. 4C. Alternatively, and as similarly discussed herein, the array of immersive sound speakers 406 may be positioned at a top edge of the first display 410, or the array of immersive sound speakers 406 may be positioned at a bottom edge of the first display 410 and a top edge of the second display 412 (e.g., between the first display 410 and the second display 412).

The single array of immersive sound speakers 406 may include a plurality of sound speakers 409. In the exemplary embodiment shown in FIG. 4C, the single array of immersive sound speakers 406 can include twelve (12) distinct sound speakers 409. However, it is to be understood that the single array of immersive sound speakers 406 can include any number of sound speakers 409 greater than two (2). For example, the single array of immersive sound speakers 406 can include three (3), six (6), ten (10), or sixteen (16) sound speakers 409. As discussed herein, each sound speaker 409 is horizontally aligned with at least one adjacent sound speaker 409 and is positioned a predetermined or known distance away from at least one adjacent sound speaker 409. Additionally, each of the sound speakers 409 forming the single array of immersive sound speakers 406 are facing in a similar direction and/or are at least partially aligned with the localized sound bubble area (see, FIGS. 6B and 6C) formed adjacent EGM 402.

In FIG. 4C, two displays 410, 412 are shown and positioned vertically with respect to one another. Thus, when the game is played at the EGM 402, the player is able to view the displays 410, 412 as being one above the other. In other embodiments, the displays 410, 412 are positioned horizontally such that one display is next to the other. Additionally, or alternatively, the electronic gaming devices may include more than two displays, wherein the plurality of displays are positioned horizontally and/or vertically with respect to one another. Moreover, each display of EGM 402 may include a flat screen display and/or a curved surface display.

The array of immersive sound speakers 406 are arranged and configured to direct game sounds, game music, game instructions, and the like, toward a predefined area (e.g., localized sound bubble area) surrounding the player at the EGM 402 (and in some cases certain bystanders surrounding the player). The player in turn is immersed in the created spatial sound at the EGM while others outside of the predefined area are not able to hear or experience the spatial sounds generated by the immersive sound speakers 406. The array of immersive sound speakers 406 may receive data of the game music, game sounds, game instructions, and the like, to be played from an EGM logic cage 414, which includes an audio controller 422 and/or a game controller 424.

In some embodiments, the EGM logic cage 414 may be implemented using one or more controllers, one or more processors, one or more digital signal processors, one or more application specific integrated circuits, one or more field programmable gate arrays, and/or the like. The EGM logic cage 414 may perform as an audio controller 422 and/or a game controller 424 and may synchronize 3D immersive sound being played by the array of immersive sound speakers 406 with events being displayed on the first display 410 and/or the second display 412. In some embodiments, an amplifier, such as a digital signal processor (DSP) amplifier 418, and a subwoofer 420 may also be included in the 3D immersive sound system of the EGM 402, as described herein.

In exemplary embodiments, the various components of EGM 402 (e.g., EGM logic cage 414, audio controller 422, game controller 424) may, at least in part, control the outputted audio data and/or the created spatial audio provided to the player of EGM 402. That is, the operation of each of the various components of EGM 402, as shown in environment, may be controlled to create the spatial audio and provide the spatial audio to the localized sound bubble area for the EGM 402. This in turn generates a 3D immersive audio experience for the player of the EGM 402. For example, the DSP amplifier 418 can adjust the output signal for each of the plurality of sound speakers 409 forming the single array of immersive sound speakers 406 to create, generate, and/or alter the spatial sound within the localized sound bubble area. The volume and/or audio data generated by each sound speaker 409 may be adjusted, modified, and/or varied to alter the spatial sound and/or provide the player with the 3D immersive audio experience, as discussed herein. Additionally, and as discussed herein (see, FIGS. 6A-6C), the output signal for each of the plurality of sound speakers 409 forming the single array of immersive sound speakers 406 can be adjusted to create, generate, and/or alter the spatial sound within the localized sound bubble area to provide various players of a community game system 3D immersive audio experiences and/or effects.

FIGS. 4D and 4E are illustrations of an exemplary embodiment of EGM 402 in accordance with embodiments of the present disclosure. In exemplary embodiment, the at least one array of immersive sound speakers may be positioned below and/or adjacent a bottom edge of the display device 404 of EGM 402. That is, and as shown in FIGS. 4D and 4E, at least one array of immersive sound speakers 406 may be positioned adjacent a bottom edge 430 of display device 404 for EGM 402. Additionally as shown, the linear array of immersive sound speakers 406 may also be positioned within a gaming cabinet 432, adjacent a button deck 434 of the EGM 402. The linear array of immersive sound speakers 406 may extend over an entire width of the gaming cabinet 432 forming EGM 402.

As a result of the linear configuration and/or the low spatial footprint required by the linear array of immersive sound speakers 406, conventional sound systems (e.g., stereo speakers, surround sound speakers) included with certain EGMs can be easily and inexpensively replaced by the linear array of immersive sound speakers 406. In an exemplary embodiment, the linear array of immersive sound speakers 406 may replace conventional sound systems and/or be positioned within the same space of the gaming cabinet 432 as the conventional sound systems, as similarly shown and discussed herein with respect to FIGS. 4D and 4E. Alternatively, the linear array of immersive sound speakers 406 can be mounted to a portion of the gaming cabinet 432 using, for example, a bracket (not shown), to quickly and inexpensively upgrade the sound system of a conventional EGM.

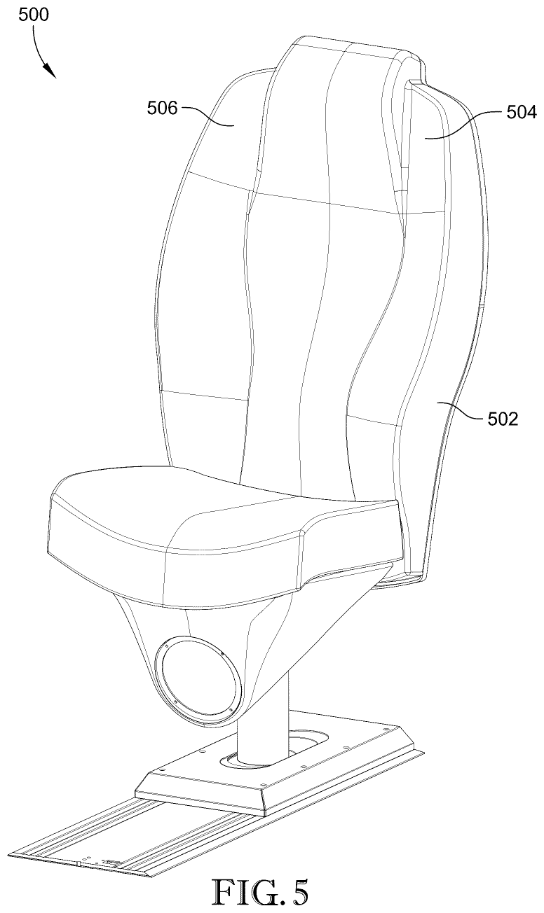

FIG. 5 illustrates an exemplary view 500 of a game chair 502 with a plurality of linear arrays of immersive sound speakers in accordance with some embodiments of the present disclosure. As shown in FIG. 5, a first linear array of immersive sound speakers 504 and a second linear array of immersive sound speakers 506 may be embedded in the chair 502. The first linear array of immersive sound speakers 504 and the second linear array of immersive sound speakers 506 may be similar to the arrays of immersive sound speakers 406, 408, as discussed herein with respect to FIGS. 4A-4E. Details of the first linear array of immersive sound speakers 504 and the second linear array of immersive sound speakers 506 are not repeated herein for brevity.

FIGS. 6A-6C illustrate exemplary views of a community gaming system 600 including a central community display 602 and a bank of EGMs including EGMs 604, 606, 608, 610, 612 in accordance with some embodiments of the present disclosure. The central community display 602 may include a game controller 618 and/or an audio controller 620 (shown in phantom). The game controller 618 of the central community display 602 may be linked, or communicatively coupled, with a game controller 622 (shown in phantom) of one or more EGMs 604-612 of the bank of EGMs. Alternatively, the game controller 618 of the central community display 602 may be linked, or communicatively coupled, with a game controller 622 of each EGM 604-612 of the bank of EGMs. As shown in FIGS. 6B and 6C, the central community display 602 may be physically separate and distant from the EGMs 604-612 of the bank of EGMs. The EGMs 604-612 of the bank of EGMs create localized sound bubble area 624, 626, 628, 630, 632 (sec, FIGS. 6B and 6C) for players playing at each EGM 604-612. That is, and as shown in FIGS. 6B and 6C, each EGM 604-612 may define a specific and/or corresponding localized sound bubble area 624-632 for a player of each EGM 604-612. Each localized sound bubble area 624-632 is generated by at least one linear array of immersive sound speakers 634-642 included within each EGM 604-612. Additionally as shown in the non-limiting example, the localized sound bubble area 624-632 generated by the at least one linear array of immersive sound speakers 634-642 may substantially surround each player chair 644-652 positioned in front of the respective EGMs 604-612. As discussed herein, the size of the localized sound bubble area 624-632 may be dependent upon, at least in part, a first anticipated distance (D1) (see, FIG. 6B) a player is spaced from the EGM 604-612 in which the player is engaging.

The central community display 602 may include one or more distinct linear arrays of immersive sound speakers 654A, 654B to create a global sound bubble area 656 (sec, FIGS. 6B and 6C) for the bystanders around the central community display 602. For example, and as shown in FIGS. 6A-6C, a linear array of immersive sound speakers 654A may be positioned in front of and substantially below the central community display 602. Additionally as shown, the linear array of immersive sound speakers 654A are also positioned between the central community display 602 and each of the EGMs 604-612 forming the bank of EGMs. As similarly discussed herein within respect to the sound speakers of the linear array of immersive sound speakers for EGMs (see, FIG. 4C), the distinct linear array of immersive sound speakers 654A may include a plurality of sound speakers 658. Each sound speaker 658 of the distinct linear array of immersive sound speakers 654A are horizontally aligned with at least one adjacent sound speaker 658 and is positioned a predetermined or known distance away from at least one adjacent sound speaker 658.

The spatial sound output by the distinct linear array of immersive sound speakers 654A to create and/or generate the global sound bubble area 656 for bystanders of the central community display 602 is dependent, at least in part, on a second anticipated distance (D2) (see, FIG. 6B) between the linear array of immersive sound speakers 654A and the chairs 644-652 positioned in front of the respective EGMs 604-612 for the bank of EGMs. That is, and as similarly discussed herein, the distinct array of immersive sound speakers 654A are arranged and configured to direct game sounds, game music, and the like, toward a predefined area (e.g., global sound bubble area) adjacent the EGMs 604-612, for bystanders viewing the central community display 602. The spatial sound generated and/or created by the distinct array of immersive sound speakers 654A may be distinct from spatial sound generated and/or created by the array of immersive sound speakers 634-642 for each EGM 604-612 of the plurality of EGMs. The bystanders are in turn immersed in the created, distinct spatial sound adjacent the EGMs 604-612, while players at the EGMs 604-612 experience the spatial sounds generated by the array of immersive sound speakers 634-642. The distinct array of immersive sound speakers 654A may receive audio data to be played from, for example, the game controller 618 and/or the audio controller 620. Alternatively, the distinct array of immersive sound speakers 654A included adjacent and/or in communication with the central community display 602 can receive audio data from a central logic cage (not shown), including the game controller 618 and/or audio controller 620.

Similar to the EGM logic cage (see, FIG. 4C), the central logic cage may be implemented using one or more controllers, one or more processors, one or more digital signal processors, one or more application specific integrated circuits, one or more field programmable gate arrays, and/or the like. The central logic cage may synchronize 3D immersive sound being played by the distinct array of immersive sound speakers 654A with events being displayed on the central community display 602. In some embodiments, an amplifier, such as a digital signal processor (DSP) amplifier, and/or a subwoofer (not shown) may also be included in immersive sound speakers 654A, as described herein. Additionally as discussed in exemplary embodiments herein, the various components of the distinct array of immersive sound speakers 654A (e.g., central logic cage) may, at least in part, control the outputted audio data and/or the distinct, created spatial audio provided to the bystanders in the global sound bubble area 656, adjacent EGMs 604-612. That is, the operation of the distinct array of immersive sound speakers 654A, and the components included therein/in electronic communication therewith, may be controlled to create the distinct spatial audio and provide the distinct spatial audio to the global sound bubble area 656. This in turn generates a 3D immersive audio experience for the bystanders viewing the central community display 602. For example, the amplifier in electronic communication with the distinct array of immersive sound speakers 654A can adjust the output signal for each of the plurality of sound speakers 658 to create, generate, and/or alter the distinct spatial sound within the global sound bubble area 656. The volume and/or audio data generated by each sound speaker 658 may be adjusted, modified, and/or varied to alter the distinct spatial sound and/or provide the bystander with the 3D immersive audio experience, as discussed herein.

To facilitate the creation and/or generation of the distinct spatial sounds within the global sound bubble area 656, adjacent to and/or beyond the localized sound bubble 624-632, the linear array of immersive sound speakers 654A may be tilted upward and/or angled. As shown in the exemplary embodiment of FIG. 6B, the sound speakers 658 of the linear array of immersive sound speakers 654A positioned below the central community display 602 are angled or tilted upwards. As a result, outputted sound signals or distinct spatial sound directed toward and at least partially defining the global sound bubble area 656 adjacent EGMs 604-612 are directed and/or projected over each EGM 604-612, and the respective players sitting in front of EGMs 604-612. Additionally, and as shown, the outputted sound signals creating and/or generating global sound bubble area 656 are also projected and/or directed over the localized sound bubble 624-632 generated by the sound signals and/or spatial sound output by at least one linear array of immersive sound speakers 634-642 included within each EGM 604-612. The directing of the distinct sound signals from the respective linear array of immersive sound speakers 634-642, 654A ensures that the localized sound bubbles 624-632 and the global sound bubble area 656 remain distinct and/or are auditorily experienced by the desired target (e.g., players v. bystanders).

In other non-limiting examples, the central community display 602 may include additional linear array of immersive sound speakers 654B (shown in phantom). As shown in FIGS. 6A-6C, additional linear array of immersive sound speakers 654B may also be positioned above the central community display 602, and/or on either side of the central community display 602. When positioned above the central community display 602, each of the speakers of the linear array of immersive sound speakers 654B are arranged and/or oriented horizontal with respect to one another. However, in the non-limiting example where the linear array of immersive sound speakers 654B are positioned on the side of the central community display 602, each speaker of the additional linear array of immersive sound speakers 654B may be positioned and/or oriented substantially vertical with respect to one another. Similar to linear array of immersive sound speakers 654A, the additional linear array of immersive sound speakers 654B facilitate the generation and/or creation of the global sound bubble area 656 for the bystanders around the central community display 602.

As shown in the exemplary embodiment, central community display 602 may be configured and/or formed as a roulette wheel. During gaming events, each player EGM 604-612 may be eligible to participate in a “community game” of roulette, to be played and displayed on the central community display 602. During the gaming event (e.g., community game of roulette), the array of immersive sound speakers 634-642 included in each EGM 604-612 may provide and/or continuously adjust spatial sound provided to each player of EGMs 604-612. In the exemplary embodiment, spatial sounds similar to a roulette ball spinning around and/or engaging with the roulette wheel depicted on the central community display 602 may be provided to the localized sound bubble area 624-632 for each EGM 604-612. However, the spatial sounds created and/or directed toward the localized sound bubble area 624-632 by the array of immersive sound speakers 634-642 may vary depending upon the position of the roulette ball on the roulette wheel depicted in the central community display 602. For example, when the roulette ball is positioned at a left most spot on the roulette wheel (e.g., “9 o'clock”), the spatial sound provided to the player in the localized sound bubble area 624 corresponding to EGM 604 may be the loudest and/or provide the most details in the spatial sound. Additionally in the instance where the roulette ball is positioned at a left most spot on the roulette wheel, the spatial sound provided to the player in the localized sound bubble area 632 corresponding to EGM 612 may be the lowest and/or provide the least amount of details in the spatial sound. This is because the roulette ball is closest to the player sitting at EGM 604, and furthest from the player at EGM 612.

Furthermore, the sound may vary and/or be graded for each distinct localized sound bubble area 626-630 for each corresponding EGM 606-610, dependent upon the distance between the respective EGM from the roulette ball displayed on the central community display 602. That is, and where the roulette ball is positioned at a left most spot on the roulette wheel, the spatial sound provided to the player in the localized sound bubble area 626 corresponding to EGM 606 may be lower than the spatial sound provided to sound bubble area 624, but greater or louder than the spatial sound provided to the player in the localized sound bubble area 628 corresponding to EGM 608. Additionally, the spatial sound provided to the player in the localized sound bubble area 628 corresponding to EGM 606 may be lower than the spatial sound provided to sound bubble area 626, but greater or louder than the spatial sound provided to the player in the localized sound bubble area 630 corresponding to EGM 610.

Simultaneous to the array of immersive sound speakers 634-642 included in each EGM 604-612 providing distinct and/or unique spatial sounds to each player located in the respective localized sound bubble areas 624-632, the distinct array of immersive sound speakers 654A positioned adjacent the central community display 602 may also provide distinct spatial sounds. More specifically, the distinct array of immersive sound speakers 654A may provide distinct spatial sounds to the global sound bubble area 656 defined behind EGMs 604-612 and/or adjacent localized sound bubble areas 624-632. The distinct spatial sound created and directed to the global sound bubble area 656 by the distinct array of immersive sound speakers 654A may be distinct from the spatial sounds provided to the localized sound bubble areas 624-632. For example, the distinct spatial sound generated and directed to the global sound bubble area 656 to be experienced by bystanders watching the central community display 602 may include music and/or information relating to the community game system 600 (e.g., “SPIN THE BIG WHEEL”).

Additionally, or alternatively, the distinct spatial sound provided to the global sound bubble area 656 may mirror that of the sound provided to the localized sound bubble areas 624-632, based on where a bystander may be positioned within the global sound bubble area 656. For example and continuing the example above where the roulette ball is positioned at a left most spot on the roulette wheel in the central community display 602, a bystander standing adjacent to and/or directly behind EGM 604 may also be provided spatial sound from the immersive sound speakers 654A that include a roulette ball engaging with a roulette wheel. However, a bystander standing adjacent to and/or directly behind EGM 612 may not be provided any spatial sound from the immersive sound speakers 654A, or alternatively may be provided with game-related music.

As the roulette ball spins around the roulette wheel displayed on the central community display 602, the spatial sound provided to the players of the EGMs 406-412, as well as the distinct spatial sound provided to bystanders, may be adjusted and/or altered. For example, as the roulette ball moves to a positioned at the top-most spot on the roulette wheel in the central community display 602 (e.g., “12 o'clock”), the spatial sound provided to the player in the localized sound bubble area 628 corresponding to EGM 608 may be the loudest and/or provide the most details in the spatial sound. In the example, the spatial sound provided to the players in the localized sound bubble areas 624, 632 corresponding to EGMs 604, 612 may be the quietest and/or provide the least detail in the spatial sound, while the spatial sound provided to the players in the localized sound bubble areas 626, 630 corresponding to EGMs 606, 610 may be in between adjacent spatial sounds.

Additionally in the example, the distinct spatial sound provided to the global sound bubble area 656 by the distinct array of immersive sound speakers 654A may also be adjusted and/or altered. That is, where the roulette ball is in the top-most spot on the roulette wheel in the central community display 602, a bystander standing adjacent to and/or directly behind EGM 608 may also be provided spatial sound from the immersive sound speakers 654A that include a roulette ball engaging with a roulette wheel. In the exemplary embodiment, a bystander standing adjacent to and/or directly behind EGMs 604, 612 may not be provided any spatial sound from the immersive sound speakers 654A, or alternatively may be provided with game-related music.

In addition to adjusting the volume and/or signal strength generated by each sound speaker of the arrays of immersive sound speakers 634-642, 654A, each individual speaker included within the arrays of immersive sound speakers 634-642, 654A may adjust operational conditions to provide the spatial sounds as discussed herein. In order to provide the 3D immersive auditory experience for a player at EGM 604, the volume or signal strength for each sound speaker included in the array of immersive sound speakers 634 may be adjusted in succession or order. For example, when the roulette ball moves from the left most position to the top-most position on the roulette wheel displayed on the central community display 602, the signal strength in the left most sound speaker of the array of immersive sound speakers 634 may decrease. Additionally, the sound signal in each adjacent sound speaker of the array of immersive sound speakers 634, including the right most sound speaker, may temporarily increase and subsequently decrease, in order from left to right, to provide the spatial sound to the localized sound bubble area 624 as the roulette ball moves. This in turn provides the 3D immersive auditory experience to the player positioned in front of EGM 604 and/or within the localized sound bubble area 624, that the roulette ball is moving away from the player as it moves within the roulette wheel displayed in the central community display 602.

The adjusting of the spatial sounds generated and/or created by the arrays of immersive sound speakers 634-642, 654A may continue while gaming events (e.g., community roulette game) are occurring on the central community display 602. Once stopped, each array of immersive sound speakers 634-642, 654A included within the community game system 600 may provide distinct spatial sounds. For example, each array of immersive sound speakers 634-642 included within each EGM 604-612 may provide spatial sounds to the localized sound bubble areas 624-632 specific to the game events occurring on the individual EGMs 604-612. Additionally, the distinct array of immersive sound speakers 654A positioned in front of the central community display 602 may generate and/or direct distinct spatial sounds to the global sound bubble area 656 including music and/or information relating to the community game system 600.

Additionally as shown, each EGM 604-612 may include a sensor 670 (shown in phantom see, FIG. 6A) positioned adjacent each array of immersive sound speakers 634-642. Sensor 670 included in EGM 604-612 may detect and/or determine the presence of a player at EGMs 604-612 of the community game system 600. In the exemplary embodiment, determining the presence (or non-presence) of a player at an EGM may adjust and/or alter the spatial sounds generated by the array of immersive sound speakers 634-642 at the EGM 604-612. For example, where sensor 670 at EGM 604 determines that a player is present at EGM 604 and/or positioned within the localized sound bubble area 624, the array of immersive sound speakers 634 included in EGM 604 may operate as similarly discussed herein. Conversely, where sensor 670 determines a player is not positioned at EGM 604 and/or not positioned within the localized sound bubble area 624, the array of immersive sound speakers 634 included in EGM 604 may provide altered spatial sounds. In one example, the array of immersive sound speakers 634 included in EGM 604 may provide and/or direct the spatial sound toward the localized sound bubble area 624, as similarly discussed herein, just at a lower or reduced volume. In another example, the array of immersive sound speakers 634 included in EGM 604 may provide and/or direct a spatial sound that is distinct from the spatial sound discussed herein with respect to the roulette ball. More specifically, and in response to determining a player is not position at EGM 604, the distinct spatial sound generated and/or directed by the array of immersive sound speakers 634 included in EGM 604 may be similar to the spatial sound generated by the distinct array of immersive sound speakers 654A positioned in front of the central community display 602. The distinct spatial sound generated by the array of immersive sound speakers 634 included in EGM 604 may be directed to the localized sound bubble area 624 corresponding to EGM 604. Additionally, or alternatively, the distinct spatial sound generated by the array of immersive sound speakers 634 included in EGM 604 may be directed to the global sound bubble area 656 of community gaming system 600 when it is determined that a player is not positioned within the localized sound bubble area 624 corresponding to EGM 604.

In some embodiments, an electronic gaming device may include at least one display device, at least one array of immersive sound speakers, a memory device storing instructions, and a game controller including a processor configured to execute the instructions stored in the memory device. The instructions, which, when executed, by the processor, may cause the game controller to: (i) cause display of gaming events on the at least one display device; and/or (ii) output audio data to the at least one array of immersive sound speakers causing spatial sound to be outputted via the at least one array of immersive sound speakers. The spatial sound is directed to a player within an engagement area at the electronic gaming device. The engagement area may be an area of the electronic gaming device, e.g., an area in which a chair or chairs may be placed. The at least one array of immersive sound speakers may include a plurality of sound speakers, and each sound speaker of the plurality of sound speakers may be targeted toward a predefined area such that sound waves outputted by the one or more speakers of the plurality of speakers surround the player within the predefined area. By way of a non-limiting example, the predefined area may include the engagement area described herein. The instructions may further cause the game controller to detect a presence of the player within the engagement area at the electronic gaming device using a sensor positioned proximate to the electronic gaming device, and in response to detecting that a player is not located within the engagement area at the electronic gaming device, alter the audio data transmitted to the at least one array of immersive sound speakers at the electronic gaming device, which causes the sound outputted by the one or more sound speakers of the plurality of sound speakers of the at least one array of immersive sound speakers to be projected to an area larger than the engagement area.

In some embodiments, a community gaming system may include at least one central community display device, and plurality of electronic gaming machines (EGMs) linked with each other and the at least one central community display device. The community gaming system may further include a memory device storing instructions, and a game controller including a processor configured to execute the instructions stored in the memory device. The instructions, which, when executed, by the processor, cause the game controller to: (i) cause display of gaming events on the at least one central community display device and on each EGM of the plurality of EGMs as synchronized with each other; (ii) output first audio data to at least one array of immersive sound speakers of an EGM of the plurality of EGMs causing spatial sound corresponding to the first audio data to be outputted directed to a player within an engagement area at the EGM via the at least one array of immersive sound speakers of the EGM; and/or (iii) output second audio data to at least one array of immersive sound speakers at the at least one central community display device causing spatial sound corresponding to the second audio data to be outputted directed to bystanders around the at least one central community display device via the at least one array of immersive sound speakers of the at least one central community display device. The at least one array of immersive sound speakers of the EGM may include a plurality of sound speakers. Each sound speaker of the plurality of sound speakers may be targeted toward a predefined area including the engagement area such that sound waves outputted by the plurality of speakers surround the player within the predefined area.

By way of a non-limiting example, the instructions may further cause the game controller to detect a presence of the player within the engagement area at the EGM using a sensor positioned proximate to the EGM, and in response to detecting that a player is not located within the engagement area at the EGM, alter the first audio data transmitted to the at least one array of immersive sound speakers at the EGM, causing the sound outputted by the sound speakers to be projected to an area larger than the engagement area. Additionally, or alternatively, the instructions may further cause the game controller to detect a gaze direction of the player within the engagement area at the EGM using a sensor positioned proximate to the EGM, and based on the detected gaze direction of the player, output the first audio data to the at least one array of immersive sound speakers of the EGM causing the spatial sound to be outputted via the at least one array of immersive sound speaker of the EGMs.

The at least one array of immersive sound speakers at the EGM may be positioned in a horizontal plane along a top edge or a bottom edge of at least one display device of the EGM. The at least one array of immersive sound speakers at the at the at least one central community display device may be positioned in a horizontal plane along an edge of the at least one central community display.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device, comprising:
at least one display device;
at least one array of immersive sound speakers positioned adjacent the at least one display device;
a memory device in electronic communication with the at least one display device, the memory device storing instructions; and
a game controller comprising a processor configured to execute the instructions stored in the memory device, which, when executed, cause the game controller to:
cause to be displayed gaming events on the at least one display device; and
output audio data, via the at least one array of immersive sound speakers, to create spatial sound, the spatial sound directed to a player positioned within a localized sound bubble area, opposite the at least one display device.

2. The electronic gaming device of claim 1, wherein the at least one array of immersive sound speakers includes a plurality of sound speakers, each sound speaker of the plurality of sound speakers horizontally aligned with at least one adjacent sound speaker and positioned a predetermined distance away from at least one adjacent sound speaker.

3. The electronic gaming device of claim 2, wherein each sound speaker of the plurality of sound speakers are facing and at least partially aligned with the localized sound bubble area formed opposite the at least one display device.

4. The electronic gaming device of claim 1, wherein the instructions further cause the game controller to:
determine if the player is positioned within the localized sound bubble area using a sensor in electronic communication with the game controller; and
in response to determining the player is not positioned within the localized sound bubble area, alter the audio data outputted by the at least one array of immersive sound speakers to one of:
cause the spatial sound to be projected to a globalized sound bubble area, adjacent the localized sound bubble area, or
reduce a volume of the spatial sound directed toward the localized sound bubble area.

5. The electronic gaming device of claim 1, wherein the at least one array of immersive sound speakers is positioned adjacent a top edge or a bottom edge of the at least one display device.

6. The electronic device of claim 1, wherein the at least one array of immersive sound speakers includes:
a first array of immersive sound speakers positioned adjacent the at least one display device; and
a second array of immersive sound speakers positioned adjacent the at least one display device, the second array of immersive sound speakers horizontally aligned with the first array of immersive sound speakers.

7. A community gaming system, comprising:
at least one central community display device;
a plurality of electronic gaming machines (EGMs) in electronic communication with each other and the at least one central community display device, each EGM of the plurality of EGMs including at least one array of immersive speakers positioned adjacent at least one display device of the EGM;
a memory device in electronic communication with at least one of the at least one central community display device or the plurality of EGMs, the memory device storing instructions; and
a game controller comprising a processor configured to execute the instructions stored in the memory device, which, when executed, cause the game controller to:
cause to be displayed gaming events on the at least one central community display device and each EGM of the plurality of EGMs as synchronized with each other;
output first audio data, via the least one array of immersive sound speakers of an EGM of the plurality of EGMs, to create a first spatial sound, the first spatial sound directed to a player positioned within a localized sound bubble area, adjacent the EGM; and
output second audio data, via at least one distinct array of immersive sound speakers positioned adjacent the at least one central community display device, to create a second spatial sound, the second spatial sound directed to at least one bystander positioned within a globalized sound bubble area formed adjacent the plurality of EGMs,
wherein the second spatial sound is distinct from the first spatial sound.

8. The community gaming system of claim 7, wherein the at least one array of immersive sound speakers of each EGM of the plurality of EGMs includes a plurality of sound speakers, each sound speaker of the plurality of sound speakers horizontally aligned with at least one adjacent sound speaker and positioned a predetermined distance away from at least one adjacent sound speaker.

9. The community gaming system of claim 8, wherein each sound speaker of the plurality of sound speakers for each EGM are facing and at least partially aligned with the localized sound bubble area formed adjacent the EGM.

10. The community gaming system of claim 7, wherein the instructions further cause the game controller to:
determine if the player is positioned within the localized sound bubble area using a sensor included within the EGM of the plurality of EGMs; and
in response to determining the player is not positioned within the localized sound bubble area, alter the first audio data outputted by the at least one array of immersive sound speakers included in the EGM to one of:
reduce a volume of the first spatial sound directed toward the localized sound bubble area, or
output the second audio data from the least one array of immersive sound speakers of the EGM of the plurality of EGMs to create and direct the second spatial sound to the at least one bystander positioned within the globalized sound bubble area using the least one array of immersive sound speakers of the EGM.

11. The community gaming system of claim 7, wherein the at least one array of immersive sound speakers for each EGM of the plurality of EGMs is positioned adjacent a top edge or a bottom edge of the at least one display device for each EGM.

12. The community gaming system of claim 7, wherein the at least one array of immersive sound speakers for each EGM of the plurality of EGMs includes:
a first array of immersive sound speakers positioned adjacent the at least one display device; and
a second array of immersive sound speakers positioned adjacent the at least one display device, the second array of immersive sound speakers horizontally aligned with the first array of immersive sound speakers.

13. The community gaming system of claim 7, wherein the at least one distinct array of immersive sound speakers of the least one central community display device includes:
a first distinct array of immersive sound speakers positioned in front of and below the at least one central community display device.

14. The community gaming system of claim 13, wherein the at least one distinct array of immersive sound speakers of the least one central community display device includes:
a second distinct array of immersive sound speakers positioned one of above or on the side of the at least one central community display device.

15. The community gaming system of claim 13, wherein the first distinct array of immersive sound speakers of the at least one central community display device includes a plurality of sound speakers, each sound speaker of the plurality of sound speakers horizontally aligned with at least one adjacent sound speaker and positioned a predetermined distance away from at least one adjacent sound speaker.

16. The community gaming system of claim 15, wherein each sound speaker of the plurality of sound speakers for the first distinct array of immersive sound speakers are angled upwards to project the second spatial sound over the plurality of EGMs.

17. The community gaming system of claim 7, wherein the instructions further cause the game controller to:
output third audio data, via the least one array of immersive sound speakers of a distinct EGM of the plurality of EGMs, to create a third spatial sound, the third spatial sound directed to a distinct player positioned within a distinct localized sound bubble area, adjacent the distinct EGM.

18. The community gaming system of claim 17, wherein the third spatial sound is one of: (i) a spatial sound distinct from the first spatial sound, or (ii) similar to the first spatial sound and at a distinct volume from the first spatial sound.

19. A method of electronic gaming implemented on community gaming system, the method comprising:
causing to be displayed a plurality gaming events on at least one central community display device and at least one electronic gaming machine (EGM) of a plurality of EGMs of the community gaming system;
outputting first audio data, via least one array of immersive sound speakers of an EGM of the plurality of EGMs, to create a first spatial sound, the first spatial sound directed to a player positioned within a localized sound bubble area, adjacent the EGM; and
outputting second audio data, via at least one distinct array of immersive sound speakers positioned adjacent the at least one central community display device, to create a second spatial sound, the second spatial sound directed to at least one bystander positioned within a globalized sound bubble area formed adjacent the plurality of EGMs,
wherein the second spatial sound is distinct from the first spatial sound.

20. The method of claim 19, further comprising:
outputting third audio data, via the least one array of immersive sound speakers of a distinct EGM of the plurality of EGMs, to create a third spatial sound, the third spatial sound directed to a distinct player positioned within a distinct localized sound bubble area, adjacent the distinct EGM,
wherein the third spatial sound is one of: (i) a spatial sound distinct from the first spatial sound, or (ii) similar to the first spatial sound and at a distinct volume from the first spatial sound.
